(19) United States
(12) Patent Application Publication
(10) Pub. No.: US 2015/0062770 A1
(43) Pub. Date: Mar. 5, 2015

(54) ENERGY EFFICIENT BI-STABLE PERMANENT MAGNET ACTUATION SYSTEM

(71) Applicant: Glen A. Robertson, Madison, AL (US)

(72) Inventor: Glen A. Robertson, Madison, AL (US)

(21) Appl. No.: 14/016,195

(22) Filed: Sep. 2, 2013

(51) Int. Cl. H01F 7/06

(52) U.S. Cl. CPC H01F 7/064
USPC 361/147

(57) ABSTRACT

Bi-stable permanent magnet actuation is a technique employed to move and magnetically hold an armature in electromechanical devices including some valves, wherein, permanent magnets are employed in a manner that places their magnetic field in a bi-stable state to allow a control coil to divert the permanent magnet's magnetic field in one of two directions within the surrounding magnetic material. Control is established using an actuation system comprising, a power source to deliver the desired level of energy, a voltage conditioner such as a DC/DC converter matched to the power source and electromechanical device, an energy storage device such as a capacitor, an output circuit such as an H-Bridge switching circuit, and a control circuit for controlling delivery of short duration current pulses from the energy storage device through the output circuit to the electromechanical device's control coil. Thus, an energy efficient bi-stable permanent magnet actuation system is produced.

### RELATED APPLICATIONS

The present application may find use in systems such as is disclosed in the U.S. Patent application entitled “COMPACT ELECTROMECHANICAL MECHANISM AND DEVICES INCORPORATING THE SAME,” having pub. No. 20120175974A1, pub. date Jul. 12, 2012, pending; U.S. Patent application entitled “DIVERGENT FLUX PATH MAGNETIC ACTUATOR AND DEVICES INCORPORATING THE SAME,” having Ser. No. 13/489,638, filed Jun. 6, 2012, pending; U.S. Patent application entitled “DIVERGENT FLUX PATH MAGNETIC ACTUATOR AND DEVICES INCORPORATING THE SAME,” having Ser. No. 13/489,682, filed Jun. 6, 2012, pending; U.S. Patent entitled “PERMANENT MAGNET LATCHING SOLENOID,” having U.S. Pat. No. 6,265,956 B1, date Jul. 24, 2001; J.P. patent, “SOLENOID ACTUATOR,” having U.S. Pat. No. 7,037,461, date 1995, U.S. Patent entitled “LATCHING SOLENOID WITH MANUAL OVERRIDE,” having U.S. Pat. No. 5,365,210, date Nov. 15, 1994; U.S. Patent entitled “ELECTROMAGNETIC DEVICE,” having U.S. Pat. No. 3,381,181, date Apr. 30, 1968; U.S. Patent entitled “DUAL POSITION LATCHING SOLENOID” having U.S. Pat. No. 3,022,450, date Feb. 20, 1962, the disclosures are hereby incorporated by reference.

Applications related to the foregoing applications include U.S. Patent application entitled “VARIABLE LIFT OPERATION OF BISTABLE ELECTROMECHANICAL POPPET VALVE ACTUATOR,” having U.S. Pat. No. 4,829,947, date May 16, 1989, U.S. Patent application entitled “SOLENOID OPERATED VALVE WITH MAGNETIC LATCH,” having U.S. Pat. No. 3,814,376, date Jun. 4, 1974, the disclosures of which applications are hereby incorporated by reference.

### FIELD OF THE INVENTION

The present invention relates generally to an energy savings bi-stable permanent magnet actuation systems, and more particularly, to an energy efficient Bi-stable Permanent Magnet Activation System (BSPMAS) that can deliver short duration current pulses to control coil that produce a short duration secondary magnetic field to divert the primary magnetic field from a permanent magnet to alternately attract moving magnetic pole pieces or the armature in a bi-stable permanent magnet actuator.

### BACKGROUND OF THE INVENTION

Bi-stable permanent magnet actuation is a technique employed to move and magnetically hold an armature in electromechanical devices including some valves. The permanent magnets are employed in a manner that places their magnetic field in a bi-stable state to allow control coil to divert the magnetic field in one of two directions within the surrounding magnetic material. Examples of bi-stable permanent magnet actuators include U.S. Pat. Nos. 3,022,450; 3,381,181; 5,365,210; 6,265,956 B1; 7,037,461, U.S. Ser. Nos. 13/489,638; 13/489,682, and Pub. No. 20120175974 A1, each having a magnetic body incasing the permanent magnet, two controls coil, and central pole piece with the control coil placed with one on either side of the permanent magnet and about the central pole piece. The control coil are connected to control electronics, connected to a power source, and form a single current directional path to produce a single directional path magnetic field to divert the permanent magnet's magnetic field in one of two directions from the permanent magnet to bi-directionally attract movable:
Central pole piece to the fixed pole ends of the magnetic body as done in U.S. Pat. Nos. 3,022,450; 3,381,181; 5,365,210; 7,037,461; 6,265,956 B1, and U.S. Ser. No. 13/489,638;
Pole ends of the magnetic body to a fixed central pole piece as done in U.S. patent pub. No. 20120175974A1; or
Single pole end of the magnetic body to a fixed central pole piece as done in U.S. Ser. No. 13/489,682.
   The moveable parts being referred to as an armature.

Typical the control electronic simple use switches connected between the power source and the control coil to direct an electrical current from the power source in one of two directions to the control coil that produce a secondary magnetic field which diverts the primary magnetic field of the permanent magnet. The secondary magnetic field reduces the primary magnetic field in one direction and increases the magnetic field in the other to cause movement of the armature. Once the armature has fully moved the power to the control coil can be turned off. The control electronics can produce a bi-directional current from a power source using an H-bridge switching circuit wherein a pair of switches is simultaneously turned on to discharge a current to the control coil with the current duration time controlled in respect to the type of switches (mechanical or integrated circuits) used. The power supply is typically fixed at or above the voltage required to achieve the proper current to the control coil. Since the control electronics typically just turns on the H-bridge switching circuit to allow the current flow from the power supply to the control coil, the amount of energy (power×on time) dissipated by the control controls will be higher than is actually necessary to cause full movement of the armature. Thus requiring the switching means in the H-bridge to be quite power intensive.

Using fixed voltage power sources makes versatility to energy saving application, like solar power, much harder, especially when high voltages or high currents are needed. Still further, as a bi-stable permanent magnet actuator increases in size the control coil increase proportionally, which increases their resistance, which increases the voltage required to get the proper current through the control coil, which increases the size of the power source.

What is needed, therefore, is a control electronics system and control coil design that is more adaptable to energy saving applications.

### SUMMARY OF THE INVENTION

A bi-stable permanent magnet actuator system (BSPMAS) that is more adaptable to energy saving applications includes control electronics comprising: a power source that can be of any power level to include low voltage batteries and solar cells with low average watts (energy per time), a voltage conditioner such as a DC/DC converter, an energy storage device such as a capacitor, an output circuit such as an H-Bridge switching circuit, and a control circuit for controlling delivery of current pulses from the energy storage device through the output circuit to the control coil, and can include segmented, parallel connected control coil to reduce the input voltage from the power source.

### BRIEF DESCRIPTION OF THE DRAWINGS

For a better understanding of the invention, reference is now made to the drawings, wherein like numerals represent similar objects throughout the figures where:

FIG. 1 shows several forms of a bi-stable permanent magnet actuator.

FIGS. 2 and 3 are alternate schematic diagram of a typical BSPMAS including representation of the center pole piece and permanent magnet of a bi-stable permanent magnet actuator;

FIG. 4, an alternate schematic diagram of the control coil designed to reduce the voltage requirement from the voltage conditioner to the storage capacitor; and

FIG. 5 is a current trace from a 1 k-lb. holding force bi-stable permanent magnet actuator.

### DETAILED DESCRIPTION OF THE INVENTION

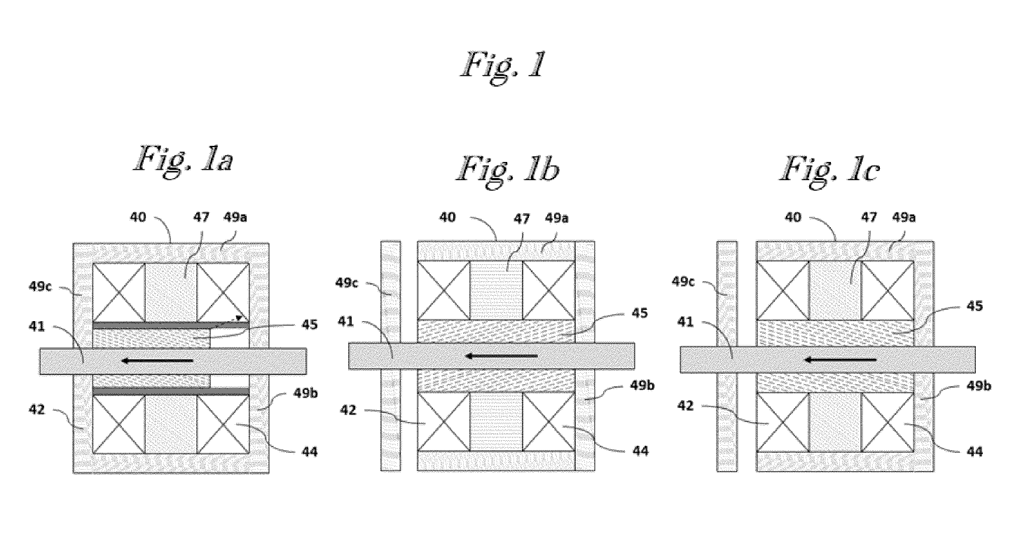

Referring to FIG. 1, a bi-stable permanent magnet actuator 40 can be produce in several forms, as shown, an outer magnetic body 49 incases control coil 42, 44 about a center pole piece 45, one on either side of a permanent magnet 47. The outer housing 49 is broken into three parts: a fixed outer part 49a and pole ends 49b, 49c that may be moveable or fixed. A shaft 41 is shown that is used to convey the movement and force from the bi-stable permanent magnet actuator 40. It is understood that bi-stable permanent magnet actuators 40 can be produced with only one coil 42 or 44.

The control coil 42, 44 form a single current directional path in one of two directions to produce a single directional path magnetic field in one of two directions to divert the permanent magnet's 47 magnetic field in one of two directions from the poles of the permanent magnet 47, wherein:

FIG. 1a, to bi-directionally attract the moveable central pole piece 45 to fixed pole end 49b or 49c as done in U.S. Pat. No. 3,022,450 and U.S. Ser. No. 13/489,638 with the shaft 41 firming attached to the central pole piece 45 but free to move through the fixed pole ends 49b, 49c;

FIG. 1b, to bi-directionally attract the moveable pole ends 49b, 49c to a fixed central pole piece 45 as done in U.S. patent pub. No. 20120175974A1 with the shaft 41 firming attached to the fixed pole ends 49b, 49c but free to move through the central pole piece 45;

FIG. 1c, to single directionally attract a moveable pole end 49c to a fixed central pole piece 45 as done in U.S. Ser. No. 13/489,682 with the shaft 41 firming attached to the fixed pole end 49c, but free to move through the central pole piece 45 and the fixed pole end 49b.

The moveable parts being referred to as an armature.

The unique characteristic of a bi-stable permanent magnet actuator 40 is that the current to the control coil 42, 44 is only required until the armature has completed moving, which is on the order of 10 s of millisecond. Power sources are typically designed to deliver a continuous current at a fixed voltage. Whereas, a fast control switch is needed to allow the gage of wire in the control coil of bi-stable permanent magnet actuators 40 to be smaller than normally would be required for continuous application of the current, otherwise the actuator would be much larger and less efficient. Further the input power (voltage×current) drives the size of the power source. For example, a bi-stable permanent magnet actuator 40 requiring 50 amps at 120 volts requires a 6 k watt power source, even though the power is only required for 10 s of milliseconds. These maybe reasons why such actuators have not become common place in the years since the invention of the bi-stable permanent magnet actuator 40 of U.S. Patent entitled “DUAL POSITION LATCHING SOLENOID” having U.S. Pat. No. 3,022,450, date Feb. 20, 1962, represented by FIG. 1a. Another reason may also be due to the more recent invention of rare earth magnets which allow bi-stable permanent magnet actuators 40 to have much higher activation and holding magnetic forces, which can be much higher than conventional solenoid actuators and allow for much wider operating gaps.

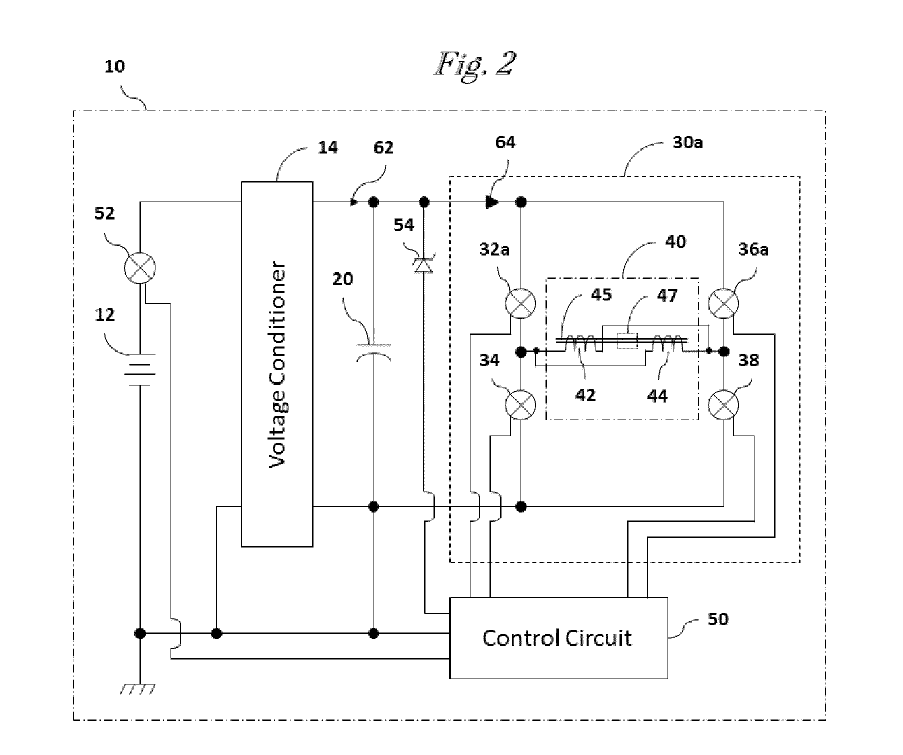

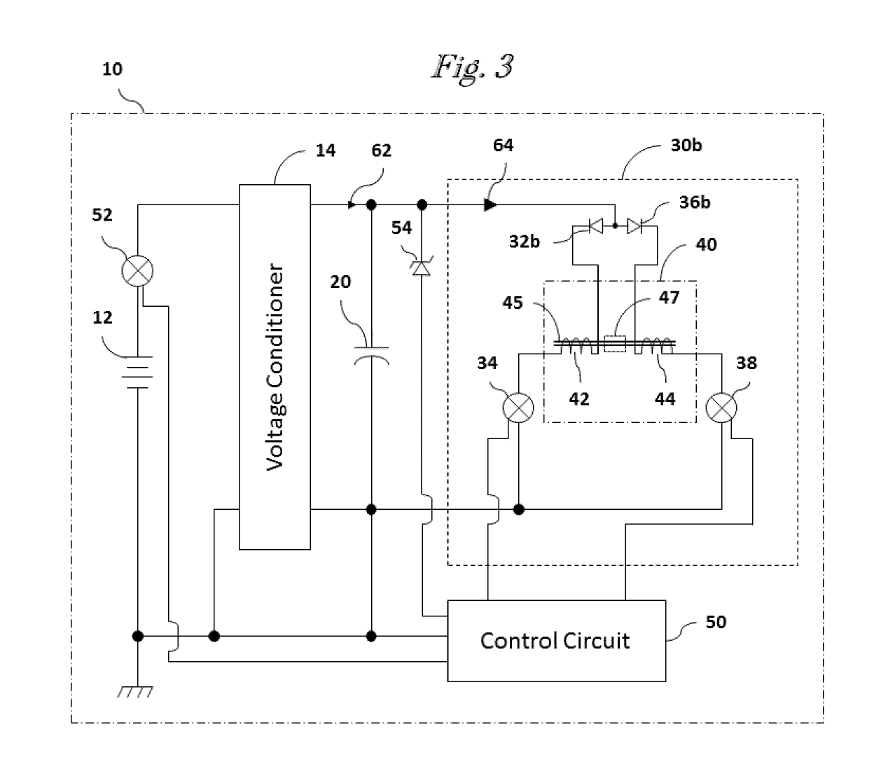

Referring to FIG. 2 and FIG. 3, alternate schematic diagrams of a BSPMAS 10 are shown including representation of the center pole piece 45 and permanent magnet 47 of the bi-stable permanent magnet actuators 40 of FIG. 1. BSPMAS 10 includes a power source 12; voltage conditioner 14; electrical energy storage capacitor 20; control circuit 50 including power switch 52 and voltage sensor (zener diode) 54; an output circuit 30a of FIG. 2 or 30b of FIG. 3; and the control coil 42, 44 of a bi-stable permanent magnet actuator 40. The voltage conditioner 14 needs to be matched to the power source 12 and the voltage needed by the bi-stable permanent magnet actuator 40. The voltage conditioner 14 can be a pass-through if no conditioning is needed, a DC/DC or AC/DC converter, a simple voltage multiplier, or a variety of other voltage conditioning circuits. A unique feature is that if the time between current pulses is long, the power source's 12 input voltage and current can be very small as from low voltage batteries and solar cells with low average watts (energy per time), whereby a voltage conditioner 14 incorporating a voltage multiplier can step-up the voltage to the storage capacitor 20 over time with a small current to the storage capacitor 20 as indicated by the small arrow 62 on the upper output of the voltage conditioner 14. Whereas, only the energy (power×time=voltage×charge) needed for the activation pulse is required to be delivered by the power source 12.

Although FIGS. 2 and 3 shows a single energy storage capacitor 20, it is well-understood in the art that a bank of capacitors may be used, or any other energy storage device that can rapidly release stored electrical energy. It is also well-understood in the art that a variety of voltage sensors 54 can be used.

In FIG. 2, four legs are arranged in the form of an “H” (an “H-bridge 30a”), each leg of the H -bridge 30a having switches 32a, 34, 36a, and 38, respectively. The H-bridge 30a is connected to the capacitor 20 and control coil 42, 44, and is used to generate a high current pulse from the capacitor 20 as indicated by the large arrow 64 bidirectional through the control coil 42, 44. The control circuit 50 controls the H-bridge 30a to switch direction of the current to the control coil 42, 44 using switches 32a, 34, 36a, and 38. A first direction current pulse is discharged from the storage capacitor 20 by activating switches 32a and 38. A second direction current pulse opposite to the first current pulse can be discharged from the storage capacitor 20 by activating switches 36a and 34. The two control coils 42 and 44 are parallel connected to reduce the voltage requirement from the voltage conditioner 14 to the storage capacitor 20. It is understood that the BSPMAS 10 of FIG. 2 would still function with bi-stable permanent magnet actuators 40 having only having one coil 42 or 44. It should be appreciated that a variety of H-bridge output circuits such as the one described with respect to FIG. 2 may be used within the scope of the present invention. Furthermore, it should be noted that additional switches may be incorporated in each leg of the H-bridge 30a to reduce the current through each switch.

In FIG. 3, four legs are arranged in the form of a dual switch 30b, each leg having switches 36b, 38 and diodes 32b, 36b, respectively. The dual switch 30b is connected to the capacitor 20 and control coil 42, 44, and is used to generate a high current pulse from the capacitor 20 as indicated by the large arrow 64 bidirectional through the control coils 42 or 44. The control circuit 50 controls the dual switch 30b to switch direction of the current to the control coils 42 or 44 using switches 34 and 38, respectfully. A first direction current pulse to control coil 42 is discharged from the storage capacitor 20 by activating switch 34. A second direction current pulse to control coil 44 opposite to the first current pulse can be discharged from the storage capacitor 20 by activating switch 38. It is understood that the BSPMAS 10 of FIG. 3 would function only with bi-stable permanent magnet actuators 40 having both control coils 42 and 44. It is also understood that the diodes 32b, 36b and switches 34, 38 could change places and still function as desired. Furthermore, it should be noted that additional switches and diodes may be incorporated in each leg of the dual switch 30b to reduce the current through each switch and diode.

It is well-understood in the art that power switch 52; H-bridge 30a switches 32a, 34, 36a and 38; and dual switch 30b switches 34, and 38, and others incorporated could be a variety of switches from manual or electrically controlled mechanical switches to integrated circuits.

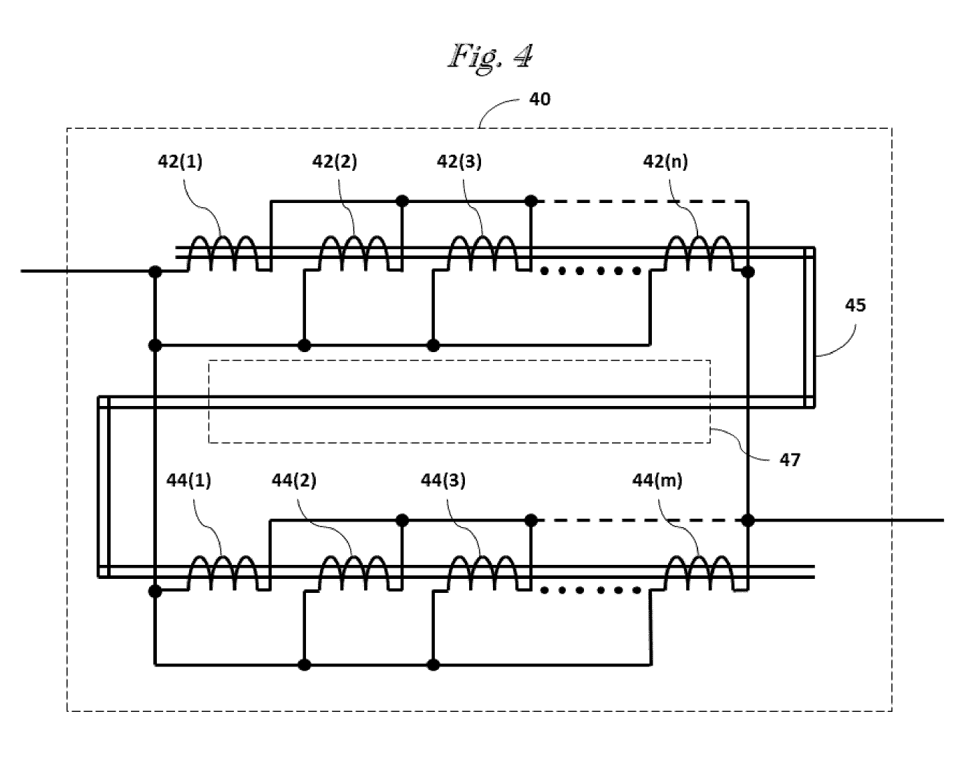

Referring now to FIG. 4, an alternate schematic diagram of the control coils 42 and 44 designed to reduce the voltage requirement from the voltage conditioner 14 to the storage capacitor 20. Control coils 42 and 44 are each divided into parallel connected control coil 42(1), 42(2), 42(3) to 42(n) and 44(1), 44(2), 44(3) to 44(m), n and m are the maximum number of the coil segments. The maximum number of segments n and m need not be equal if so desired. Unequal maximum number of segments n and m maybe desirable when the magnetic force on one side is needed to be larger than on the other at current activation. All segments 42(1), 42(2), 42(3) to 42(n) and 44(1), 44(2), 44(3) to 44(m) are placed about the center pole piece 45 of a bi-stable permanent magnet actuator 40 as shown for the control coil in in FIG. 1.

Operation of the BSPMAS 10 of FIG. 2, FIG. 3 or with coil option of FIG. 4 is similar and begins by closing switch 52 by control circuit 50 or by an operator if a simple mechanical switch is used to allow current from the power source 12 to inner the voltage conditioner 14. The voltage on the storage capacitor 20 will then rise until the control circuit 50 senses, through sensor 54 or other means, the proper voltage needed before activating the output circuit 30a or 30b.

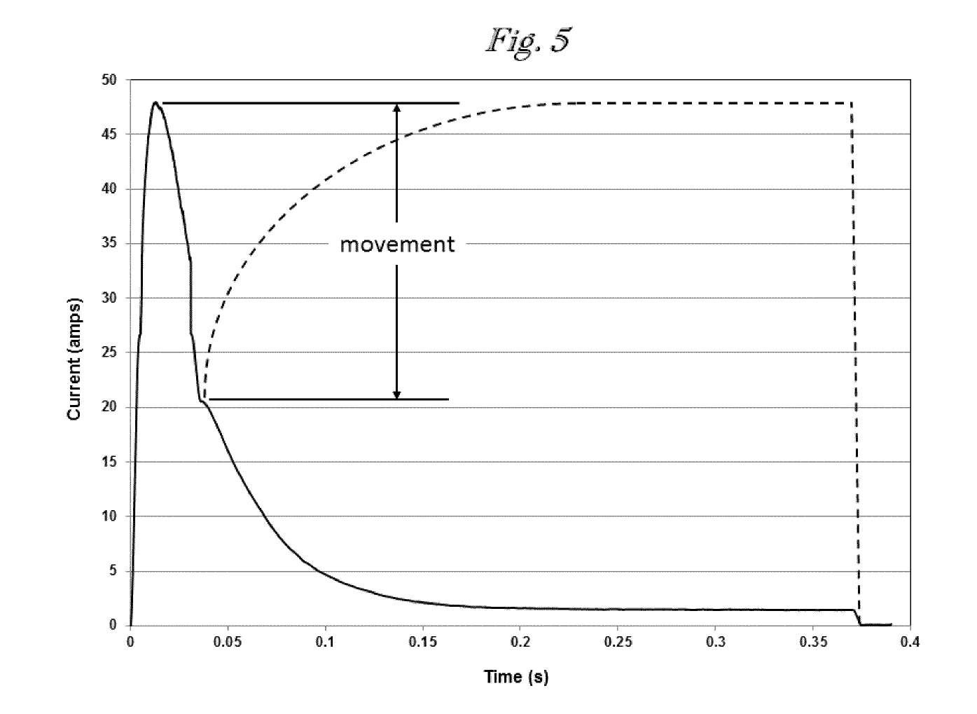

Typical time durations that the high current 64 through output circuit 30a or 30b is turn on can be very small, on order of 10 s of milliseconds. As a long time duration example from activation to armature final movement (˜45 ms), FIG. 5 shows the current trace through a bi-stable permanent magnet actuator 40 in like to FIG. 1b from a bank of four parallel connected 2200 uF capacitors rated at 200V to provide a 8800 uF storage capacitor 20. The capacitor 20 was charged to 120 V at a rate of 0.1 amps. The bi-stable permanent magnet actuator 40 was designed with a magnetic holding force of approximately 1 k lbs. using rare earth permanent magnets and a bidirectional armature movement of approximately 0.150 inches. The control coils 42 and 44 were wound using 32 awg wire (fusing current 52 A@32 ms, 0.091 amps continuous). Each control coil 42 and 44 was composed of four parallel connected control coils. The output circuit was a mechanical switch (rated at 3 amps, continuous) forming an H-Bridge 30a switch allowing the time to close to be long (˜370 ms). The armature movement part (˜30 ms) of the trace is shown in FIG. 5 with the current tail-off indicating the drain off of the storage capacitor 20 while the mechanical switch was still closed. The dotted line in FIG. 5 represents the current trace had the power source 12 been from a typical power supply rated at ˜6 k watts. The area between the dotted line and the solid line represents the energy saved. Opposite activation produces a similar current trace with movement of the armature in the opposite direction.

Numerous characteristics and advantages of the invention covered by this document have been set forth in the foregoing description. It will be understood, however, that this disclosure is, in many aspects, only illustrative. Changes may be made in details, particularly in matters of shape, size and arrangement of parts without exceeding the scope of the invention. The invention's scope is defined in the language in which the appended claims are expressed.

What is claimed is:

1. A Bi-Stable Permanent Magnet Actuation System (BSPMAS) for bi-stable permanent magnet actuators comprising:
a power source to deliver the desired level of electrical energy;
a voltage conditioner to by-pass, rectify, step-down or step-up the voltage from the power source;
an energy storage device to receive and store the electrical energy from the voltage conditioner;
an output circuit coupled to the energy storage device, wherein the output circuit comprises a plurality of switching means for controlling delivery of bidirectional current pulses from the energy storage device to the control coil of a bi-stable permanent magnet actuator;
a control coil, wherein the control coil is an integral part of a bi-stable permanent magnet actuator; and
a control circuit to turn on the power source by switching means, to sense the voltage on the energy storage device by sensing circuit, and to activate the switching means of the output circuit,
wherein upon switching on of the power source, the voltage conditioner begins sending charge to the energy storage device; upon sensing the correct voltage, the control circuit can simultaneously turns on at least two of the switching means of the output circuit to discharge current in one of two directions to the control coil dependent on the two switching means simultaneously turned on.

2. The BSPMAS of claim 1, wherein the output circuit further comprises an H-bridge output circuit.

3. The BSPMAS of claim 1 wherein the control coil comprises two parallel connected coils to reduce the voltage requirement out of the voltage conditioner to the energy storage device.

4. The BSPMAS of claim 1, wherein;
the control coil comprises two independent coils, wherein the control coil is an integral part of a bi-stable permanent magnet actuator;
the output circuit comprises a plurality of diode and switching means; and
the output circuit can alternately turn on each switching means to discharge a current pulse alternately to each independent coil with the current being of opposite direction in each coil.

5. The BSPMAS of claims 1, 3, and 4, wherein each control coil comprises a plurality of parallel connected coils to reduce the voltage from the voltage conditioner to the energy storage device.

6. The BSPMAS of claims 1, 4, wherein the energy storage device further comprises at least one capacitor.

7. The BSPMAS of claims 1, 4, wherein the switching means further comprises at least one manual mechanical switch.

8. The BSPMAS of claims 1, 4, wherein the switching means further comprises at least one electrically controllable mechanical switch.

9. The BSPMAS of claims 1, 4, wherein the switching means further comprises at least one SCR.

10. The BSPMAS of claims 1, 4, wherein the switching means further comprises at least one IGBT.

11. The BSPMAS of claims 1, 4, wherein the switching means further comprises at least one MOSFET.

12. The BSPMAS of claims 1, 4, wherein the switching means further comprises at least one Transistor.

13. The BSPMAS of claims 1, 4, wherein the switching means further comprises at least one Thyristor.

14. The BSPMAS of claims 1, 4, wherein the control circuit sensor circuit comprises a zener diode.

15. The BSPMAS of claims 1, 4, wherein the output circuit is sequenced to deliver a bidirectional current pulse to a bi-stable permanent magnet actuator.

16. The BSPMAS of claims 1, 4 with respect to claims 3, 5, wherein the output circuit delivers a short duration current pulse to the control coil from an energy storage device with peak amperage higher than normally desired under continuous operation and lower than the fusing amperage for the gage wire used to wound the control coil.

17. The BSPMAS of claims 1, 4, used to provide short duration power (voltage×current) pulses to control coil that save energy over conventional power sources used for continuous operation at the same power.

18. The BSPMAS of claims 1, 4, wherein the voltage conditioner further comprises a voltage multiplier.

19. The BSPMAS of claims 1, 4, wherein the voltage conditioner further comprises a DC/DC converter.

20. The BSPMAS of claims 1, 4, wherein the voltage conditioner further comprises an AC/DC converter.
